(19) United States
(12) Patent Application Publication
(10) Pub. No.: US 2021/0063674 A1
(43) Pub. Date: Mar. 4, 2021

(54) LENS MODULE, OPTICAL LENS, AND ELECTRONIC DEVICE

(71) Applicant: HON HAI PRECISION INDUSTRY CO., LTD., New Taipei (TW)

(72) Inventors: PO-CHOU CHEN, Tu-Cheng (TW); CHUN-CHENG KO, New Taipei (TW)

(21) Appl. No.: 17/002,060

(22) Filed: Aug. 25, 2020

(30) Foreign Application Priority Data
Aug. 30, 2019 (CN) 201910814934.1

(51) Int. Cl. G02B 7/02

(52) U.S. Cl. CPC G02B 7/021; G02B 7/022

(57) ABSTRACT

A lens module reducing stray light includes at least two overlapping lenses, each of the lenses includes a light passing area and a flange area outside the light passing area. Each of the lenses includes a first surface disposed toward one adjacent lens. The first surface has optical microstructures, the optical microstructures scatter light entering the flange area. The first surface also includes an overlapping portion protruding from the first surface in the flange area. Adjacent lenses are accurately aligned by the overlapping portion, the overlapping portion includes a second surface away from the first surface. The second surface of each lens is in contact with the second surface of the adjacent lens, and the second surface is a smooth surface. An optical lens and an electronic device are also disclosed.

### FIELD

The subject matter herein generally relates to imaging.

### BACKGROUND

Stray light is light propagating abnormally or randomly in an optical system.

The stray light may cause attenuation of performance of an imaging system, reduce the modulation transfer function of a lens, and endanger the imaging quality of the lens. The specific manifestations are reduced imaging clarity, reduced layering, and reduced color saturation. Sandblasting the flange surface of the lens can reduce the stray light, but the flange surface sandblasting may reduce the accuracy of fixing two adjacent lenses together, resulting in poor image quality.

Therefore, improvement is desired.

### BRIEF DESCRIPTION OF THE DRAWINGS

Implementations of the present disclosure will now be described, by way of embodiments, with reference to the attached figures.

FIG. 1 is a cross-sectional view and an enlarged view of one embodiment of a lens module of the present disclosure.

FIG. 2A is an optical path diagram of light passing through a first surface of the lens module of FIG. 1 with an optical microstructure. FIG. 2B is an optical path diagram of light passing through the first surface without the optical microstructures.

FIG. 3 is a top view of a lens unit of the lens module of FIG. 1.

FIG. 4 is a top view of another embodiment of a lens unit of the lens module.

FIG. 5 is a top view of yet another embodiment of a lens unit of the lens module.

FIG. 6 is a schematic cross-sectional view of an embodiment of an optical lens.

FIG. 7 is a schematic of an embodiment of an electronic device of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

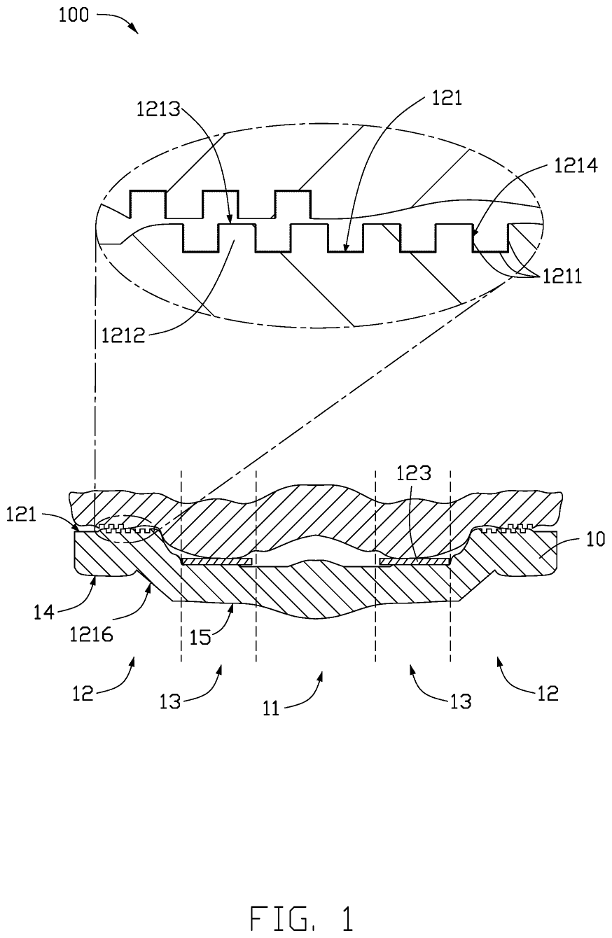

FIG. 1 illustrates a lens module 100 in accordance with an embodiment of the present disclosure.

The lens module 100 includes at least two overlapping lenses 10. The lens 10 includes a light passing area 11 and a flange area 12, and the light passing area 11 extends outward to form the flange area 12. The light passing areas 11 of the two lenses 10 correspond to each other, and the flange areas 12 of the two lenses 10 correspond to each other. The light passing area 11 is used to focus incoming light and form an object image, and the flange area 12 is used to achieve alignment between adjacent lens 10.

In the embodiment, each lens 10 includes at least one first surface 121. When two lenses 10 are superimposed, the first surface 121 of one lens 10 and the first surface 121 of the other lens 10 face each other. The first surface 121 is provided with a plurality of optical microstructures 1211 in the flange area 12, and the optical microstructure 1211 scatters the light entering the flange area 12, to reduce stray light.

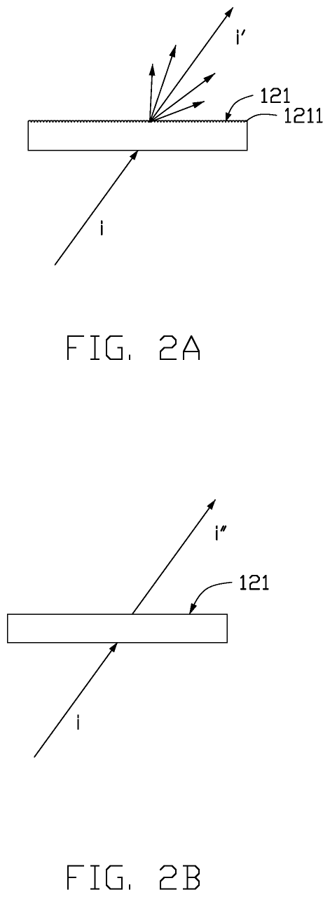

FIG. 2A illustrates the principle of reducing stray light. When light i is incident from below the first surface 121, the light i is scattered by the optical microstructure 1211 into multiple outgoing beams due to the existence of the optical microstructure 1211. This should be compared with the absence of the optical microstructure 1211, FIG. 2B illustrates the light i incident from below the first surface 121, the light i″ emitted from the first surface 121 is not scattered, and the light i″ may cause stray light.

The first surface 121 is further provided with an overlapping portion 1212 protruding into the flange area 12. In the embodiment, a size of the overlapping portion 1212 is much larger than a size of the optical microstructure 1211. The overlapping portion 1212 is used to align two adjacent lenses 10. The overlapping portion 1212 includes a second surface 1213 away from the first surface 121, and the second surface 1213 of one lens 10 is in contact with the second surface 1213 of the adjacent lens 10. The second surface 1213 is a smooth surface, the second surface 1213 not being provided with any optical microstructure 1211. The second surface 1213 is the smooth surface, which can ensure the alignment accuracy of the optical axes of the two lenses 10.

In the embodiment, the overlapping portion 1212 further includes a connecting surface 1214, and the connecting surface 1214 is connected to the first surface 121 and the second surface 1213. The optical microstructure 1211 is also formed on the connecting surface 1214 to scatter the light emitted from the connecting surface 1214 and further reduce the stray light.

In the embodiment, the optical microstructure 1211 includes protrusions or grooves of various shapes formed by techniques such as sandblasting or etching or both.

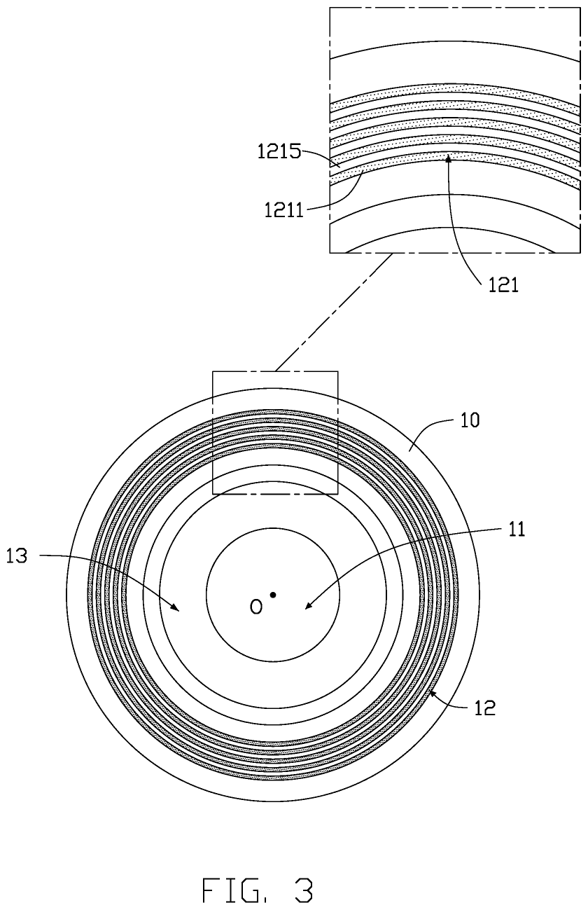

FIG. 3 shows that the overlapping portion 1212 may include a plurality of sub overlapping portions 1215, and the sub overlapping portions 1215 are disposed on the first surface 121 and arranged at a distance from each other. The sub overlapping portion 1215 is a concentric structure with the center position O of the light passing area 11 as the center, and the optical microstructure 1211 is disposed on the first surface 121 between the plurality of sub overlapping portions 1215.

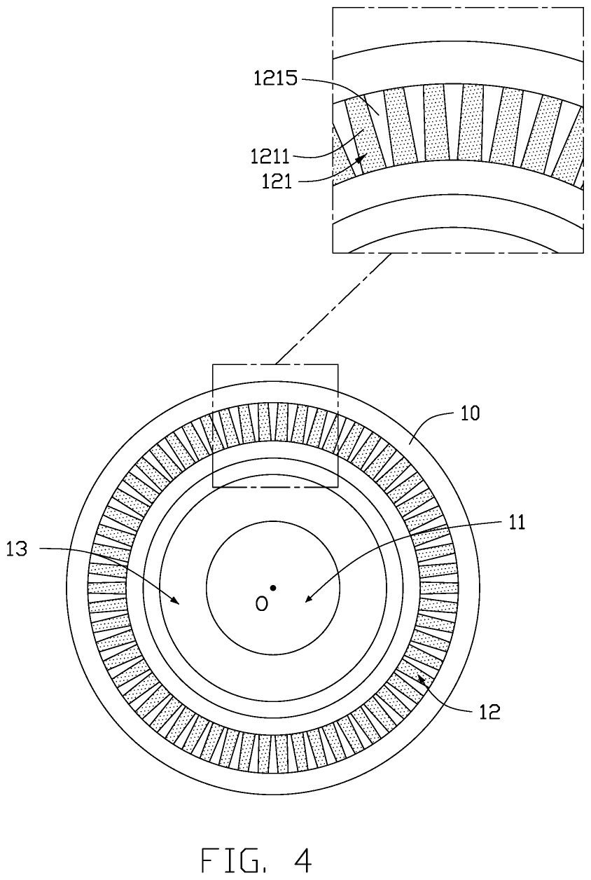

In other embodiments, referring to FIG. 4, the sub overlapping portion 1215 may also be a strip structure formed by diverging from the center position O of the light passing area 11, and penetrate the flange area 12 in a radial direction. The optical microstructure 1211 is disposed on the first surface 121 between the plurality of sub overlapping portions 1215.

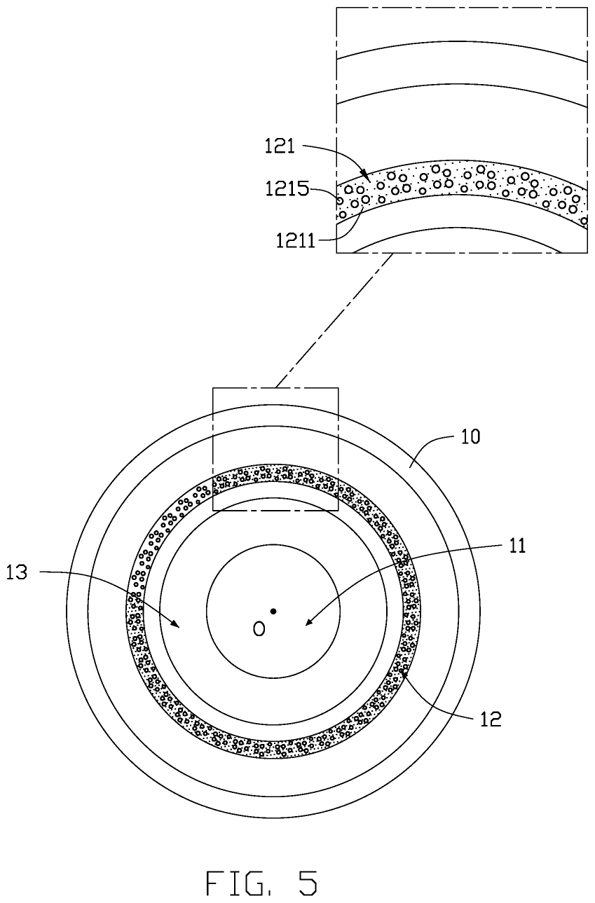

In other embodiments, referring to FIG. 5, the sub overlapping portion 1215 may also be a protruding structure randomly distributed on the first surface 121. The protruding structure may be a rotating body or a polygonal body, and the optical microstructure 1211 is disposed on the first surface 121 between the plurality of sub overlapping portion 1215.

In the embodiment, the lens 10 further includes a shading area 13, the shading area 13 is connected between the flange area 12 and the light passing area 11, and a first shading member 123 is provided between the shading areas 13 of the two adjacent lenses 10. In the embodiment, the first shading member 123 is used to block or absorb light entering the shading area 13.

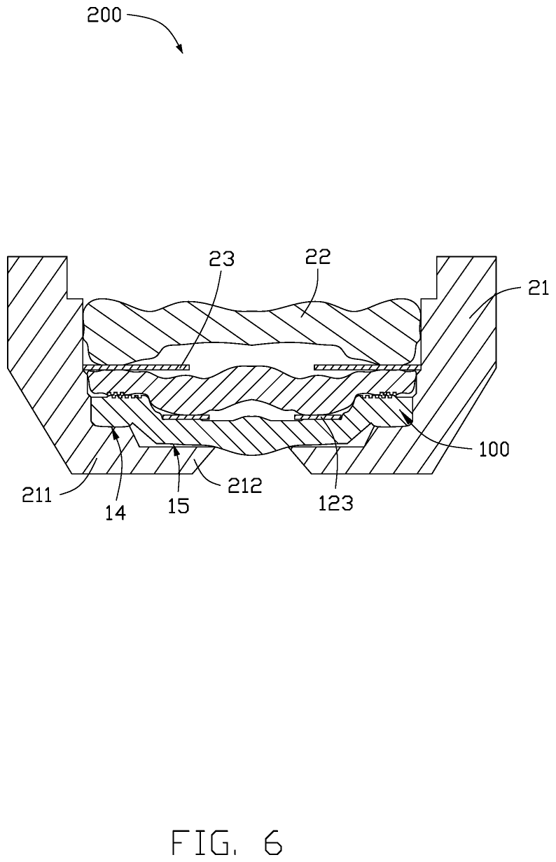

FIG. 6 illustrates an optical lens 200 in accordance with an embodiment of the present disclosure.

The optical lens 200 includes the lens module 100 and a lens barrel 21, and the lens module 100 is received in the lens barrel 21.

FIG. 6 illustrates one of the lenses 10 located outside the lens module 100 further includes a third surface 1216, and the third surface 1216 is disposed opposite to the first surface 121. The third surface 1216 forms a first bearing surface 14 in the flange area 12, and the third surface 1216 forms a second bearing surface 15 in the shading area 13.

The lens barrel 21 may be substantially a cylindrical structure, a first supporting portion 211 is formed at a position corresponding to the first bearing surface 14 inside the lens barrel 21, and a second supporting portion 212 is formed at a position corresponding to the second bearing surface 15 inside the lens barrel 21. The lens module 100 is disposed on the first supporting portion 211 and the second supporting portion 212 through the first bearing surface 14 and the second bearing surface 15.

In the embodiment, the optical lens 200 further includes a lens unit 22, the lens unit 22 is received in the lens barrel 21, and the lens unit 22 is disposed on a side of the lens module 100 away from the first bearing surface 14.

In the embodiment, the optical lens 200 further includes a second shading member 23, and the second shading member 23 is disposed between the lens unit 22 and the lens module 100.

The lens unit 22 is provided with a coating (not shown) on a side away from the lens module 100, the coating increases light transmittance of the optical lens 200. The lens unit 22 may be a common lens, the surface of the lens unit 22 is not provided with the optical microstructure 1211 and the overlapping portion 1212.

In the embodiment, the optical lens 200 further includes a filtering member (not shown) and an optical sensor (not shown), and the filtering member is disposed between the optical sensor and the lens unit 22.

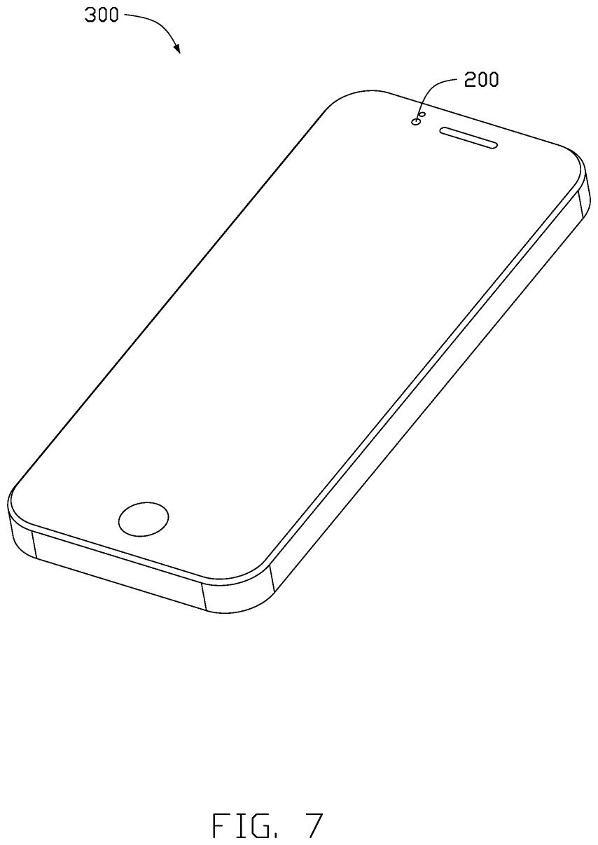

FIG. 7 illustrates an electronic device 300 in accordance with an embodiment of the present disclosure.

The electronic device 300 includes at least one optical lens 200, and the electronic device 300 may be a mobile phone, a tablet computer, or a video camera with a camera function.

The optical microstructure 1211 is disposed in the flange area 12, so that the light passing through the flange area 12 is scattered, reducing the generation of stray light during image captures. At the same time, the flange area 12 is also provided with the overlapping portion 1212, the overlapping portion 1212 has a smooth contact surface to ensure the alignment accuracy of the optical axis of the lens 10.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

What is claimed is:

1. A lens module comprising:
at least two overlapping lenses, each of the at least two lenses comprising a light passing area and a flange area extending from outside of the light passing area;
wherein each of the at least two lenses comprises at least one first surface, the at least one first surface is provided with a plurality of optical microstructures, and the plurality of optical microstructures is configured to scatter light entering the flange area; and
wherein the at least one first surface is provided with an overlapping portion protruding in the flange area, the overlapping portion is configured to align two adjacent lenses, the overlapping portion comprises a second surface away from the at least one first surface, the second surface of each of the at least two lenses is in contact with the second surface of the adjacent lens, and the second surface is a smooth surface.

2. The lens module according to claim 1, wherein the overlapping portion further comprises a connecting surface, the connecting surface is coupled to the at least one first surface and the second surface, and the plurality of optical microstructures is also formed on the connecting surface.

3. The lens module according to claim 1, wherein the overlapping portion comprises a plurality of sub overlapping portions, and the plurality of sub overlapping portions is disposed on the at least one first surface and arranged at a distance from each other, the light passing area defines a center position, the plurality of sub overlapping portions is a concentric structure with the center position as a center, and the plurality of optical microstructures is disposed on the at least one first surface between the plurality of sub overlapping portions.

4. The lens module according to claim 1, wherein the overlapping portion comprises a plurality of sub overlapping portions, and the plurality of sub overlapping portions is disposed on the at least one first surface and arranged at a distance from each other, the light passing area defines a center position, the plurality of sub overlapping portions is a strip structure formed by diverging from the center position, the plurality of sub overlapping portions penetrates the flange area in a radial direction, and the plurality of optical microstructures is disposed on the at least one first surface between the plurality of sub overlapping portions.

5. The lens module according to claim 1, wherein the overlapping portion comprises a plurality of sub overlapping portions randomly distributed on the at least one first surface, the plurality of sub overlapping portions is a protruding structure, and the plurality of optical microstructures is disposed on the at least one first surface between the plurality of sub overlapping portions.

6. The lens module according to claim 5, wherein the plurality of optical microstructures is a protruding structure or a grooving structure.

7. The lens module according to claim 1, wherein each of the at least two lenses further comprises a shading area, the shading area is coupled between the flange area and the light passing area, and a first shading member is provided between the shading areas of the two adjacent lenses.

8. An optical lens comprising:
a lens barrel;
a lens module received in the lens barrel;
wherein the lens module comprises at least two overlapping lenses, and each of the at least two lenses comprises a light passing area and a flange area extending from outside of the light passing area;
wherein each of the at least two lenses comprises at least one first surface, the at least one first surface is provided with a plurality of optical microstructures, and the plurality of optical microstructures is configured to scatter light entering the flange area; and
wherein the at least one first surface is provided with an overlapping portion protruding in the flange area, the overlapping portion is configured to align two adjacent lenses, the overlapping portion comprises a second surface away from the at least one first surface, the second surface of each of the at least two lenses is in contact with the second surface of the adjacent lens, and the second surface is a smooth surface.

9. The optical lens according to claim 8, wherein the overlapping portion further comprises a connecting surface, the connecting surface is coupled to the at least one first surface and the second surface, and the plurality of optical microstructures is also formed on the connecting surface.

10. The optical lens according to claim 8, wherein the overlapping portion comprises a plurality of sub overlapping portions, and the plurality of sub overlapping portions is disposed on the at least one first surface and arranged at a distance from each other, the light passing area defines a center position, the plurality of sub overlapping portions is a concentric structure with the center position as a center, and the plurality of optical microstructures is disposed on the at least one first surface between the plurality of sub overlapping portions.

11. The optical lens according to claim 8, wherein the overlapping portion comprises a plurality of sub overlapping portions, and the plurality of sub overlapping portions is disposed on the at least one first surface and arranged at a distance from each other, the light passing area defines a center position, the plurality of sub overlapping portions is a strip structure formed by diverging from the center position, the plurality of sub overlapping portions penetrates the flange area in a radial direction, and the plurality of optical microstructures is disposed on the at least one first surface between the plurality of sub overlapping portions.

12. The optical lens according to claim 8, wherein the overlapping portion comprises a plurality of sub overlapping portions randomly distributed on the at least one first surface, the plurality of sub overlapping portions is a protruding structure, and the plurality of optical microstructures is disposed on the at least one first surface between the plurality of sub overlapping portions.

13. The optical lens according to claim 12, wherein the plurality of optical microstructures is a protruding structure or a grooving structure.

14. The optical lens according to claim 8, wherein each of the at least two lenses further comprises a shading area, the shading area is coupled between the flange area and the light passing area, and a first shading member is provided between the shading areas of the two adjacent lenses.

15. The optical lens according to claim 14, wherein one of the at least two lenses located outside the lens module further comprises a third surface, the third surface is disposed opposite to the at least one first surface, the third surface forms a first bearing surface in the flange area and a second bearing surface in the shading area; and wherein the lens barrel comprises a first supporting portion and a second supporting portion, the first supporting portion is formed at a position corresponding to the first bearing surface inside the lens barrel, and the second supporting portion is formed at a position corresponding to the second bearing surface inside the lens barrel, and the lens module is disposed on the first supporting portion and the second supporting portion through the first bearing surface and the second bearing surface.

16. The optical lens according to claim 15, wherein the optical lens further comprises a lens unit, the lens unit is received in the lens barrel and disposed on a side of the lens module away from the first bearing surface, and a second shading member is disposed between the lens unit and the lens module.

17. An electronic device comprising:
at least one optical lens;
wherein the at least one optical lens comprises a lens barrel and a lens module, and the lens module is received in the lens barrel;
wherein the lens module comprises at least two overlapping lenses, each of the at least two lenses comprises a light passing area and a flange area extending from outside of the light passing area;
wherein each of the at least two lenses comprises at least one first surface, the at least one first surface is provided with a plurality of optical microstructures, and the plurality of optical microstructures is configured to scatter light entering the flange area; and
wherein the at least one first surface is provided with an overlapping portion protruding in the flange area, the overlapping portion is configured to align two adjacent lenses, the overlapping portion comprises a second surface away from the at least one first surface, the second surface of each of the at least two lenses is in contact with the second surface of the adjacent lens, and the second surface is a smooth surface.

18. The electronic device according to claim 17, wherein the overlapping portion further comprises a connecting surface, the connecting surface is coupled to the at least one first surface and the second surface, and the plurality of optical microstructures is also formed on the connecting surface.

19. The electronic device according to claim 17, wherein the overlapping portion comprises a plurality of sub overlapping portions, and the plurality of sub overlapping portions is disposed on the at least one first surface and arranged at a distance from each other, the light passing area defines a center position, the plurality of sub overlapping portions is a concentric structure with the center position as a center, and the plurality of optical microstructures is disposed on the at least one first surface between the plurality of sub overlapping portions.

20. The electronic device according to claim 17, wherein the overlapping portion comprises a plurality of sub overlapping portions, and the plurality of sub overlapping portions is disposed on the at least one first surface and arranged at a distance from each other, the light passing area defines a center position, the plurality of sub overlapping portions is a strip structure formed by diverging from the center position, the plurality of sub overlapping portions penetrates the flange area in a radial direction, and the plurality of optical microstructures is disposed on the at least one first surface between the plurality of sub overlapping portions.
